(19) United States
(12) Patent Application Publication
(10) Pub. No.: US 2014/0054316 A1
(43) Pub. Date: Feb. 27, 2014

(54) Popcorn Butter Dispenser

(71) Applicants: Vanessa Mazzone Lehman, Westmont, IL (US); Carl F. Mazzone, Park Ridge, IL (US); Mark A. Tomassini, River Forest, IL (US)

(72) Inventors: Vanessa Mazzone Lehman, Westmont, IL (US); Carl F. Mazzone, Park Ridge, IL (US); Mark A. Tomassini, River Forest, IL (US)

(21) Appl. No.: 13/966,202

(22) Filed: Aug. 13, 2013

Related U.S. Application Data
(60) Provisional application No. 61/682,753, filed on Aug. 13, 2012.

(51) Int. Cl. B67D 7/60

(52) U.S. Cl. CPC B67D 7/60
USPC 222/82; 222/565; 222/478

(57) ABSTRACT

The invention provides a popcorn butter dispenser comprising an elongate tube having perforations along its length allow butter or flavoring to be evenly distributed throughout an entire container of popcorn as opposed to coating only the kernels on top. This dispenser is able to function equally well with real melted butter as well as flavored oil based toppings. The popcorn butter dispenser is manufactured of suitable materials such as lightweight stainless steel, for example.

### CLAIM OF PRIORITY

This patent application claims priority under 35 USC 119 (e) (1) from U.S. Provisional Patent Application Ser. No. 61/682,753 filed Aug. 13, 2012, of Vanessa Lehman entitled, “Popcorn Butter Dispenser.”

### FIELD OF THE INVENTION

The present invention pertains to the field of popcorn machines, and more specifically to the field of dispensing flavorings to popcorn.

### BACKGROUND OF THE INVENTION

The prior art has put forth several designs for dispensing flavorings to popcorn. Among these are:

U.S. Pat. No. 5,065,927 to Seymour Wahl and George Spector describes an apparatus for dispensing melted butter into a container of popcorn. This apparatus has a mechanism that sprays melted butter evenly throughout the popcorn.

U.S. Pat. No. 7,717,144 to Philip M. Bottega describes a device for applying salt and melted butter into popcorn which comprises a perforated straw like component having a sealed lower end. A funnel component is integral with an upper end of the perforated straw like component. When the perforated straw like component is inserted into the popcorn, salt and melted butter are poured into the funnel component and then flow out through the perforated straw like component into the popcorn.

U.S. Pat. No. 7,082,891 to Travis L. Watson describes a food product flavoring apparatus that includes a receptacle with a dispensing base, nozzles positioned above the dispensing base and a vessel holding a liquid flavoring. The liquid flavoring is delivered from the vessel to the nozzles through a conduit and a pump. The liquid flavoring is sprayed from the nozzles, uniformly covering a food product such as popcorn that is lying on the dispensing base. Following application of the liquid flavoring, vanes on the dispensing base are adjusted such that flavored popcorn is released through the dispensing base. The popcorn subsequently is funneled into a container through a hopper below the dispensing base.

US Patent 2005/0244549 to Trent W. Ling describes a disposable prefilled food condiment dispenser that includes an elongated hollow agitator having an openable end and another end connected to a reservoir filled with a food condiment such as popcorn topping. A food container clip extends from the agitator or reservoir to removably attach the dispenser to a food container. The openable end of the elongated hollow agitator preferably has an opening and a removable cap or seal to close the opening. Popcorn topping such as butter is easily distributed throughout a popcorn bag, box or bucket. The dispenser is portable and eliminates a need to shake a container and spill the popcorn.

None of these prior art references describe the present invention.

### SUMMARY OF THE INVENTION

It is an object of the present invention to provide an improved popcorn butter dispenser that coats kernels evenly throughout a container holding the popcorn.

It is a further object of the present invention to provide an improved popcorn butter dispenser that coats kernels evenly throughout a container holding the popcorn for residential use.

It is a still further object of the present invention to provide an improved popcorn butter dispenser that coats kernels evenly throughout a container holding the popcorn for commercial use.

### BRIEF DESCRIPTION OF THE DRAWINGS

FIG. 1 is a perspective front diagonal view diagramming a home butter dispenser with an opening to receive butter, a pump, and a popcorn butter dispenser tube, wherein the dispensing tube has four sides.

FIG. 2 is a perspective side view showing a home butter dispenser with a removably attachable dispenser tube which a user pumps up and down to squirt butter out the tube's holes wherein the dispensing tube has four sides.

FIG. 3 is a close up view of the dispenser tube for a residential version of the popcorn butter dispenser of the present invention, wherein the dispensing tube has a circular cross-section.

FIG. 4 is a close up view of the dispenser tube for a commercial version of the popcorn butter dispenser of the present invention, wherein the dispensing tube has a circular cross-section.

### DETAILED DESCRIPTION OF THE INVENTION

Popcorn is a popular snack in many places. Movie theaters serve popcorn. Popcorn also is a mainstay at major sporting events, bars, circuses and homes throughout the nation. Where there is popcorn, there likely are butter dispensers. It is a common experience when eating popcorn that most of the tasty buttery kernels stay at the top of the container. By the time a consumer gets through the first few handfuls, the taste dwindles as the top laced kernels are eaten. The popcorn butter dispenser addresses this issue with its intent to make the kernels at the bottom of the container as flavorful as the ones at the top.

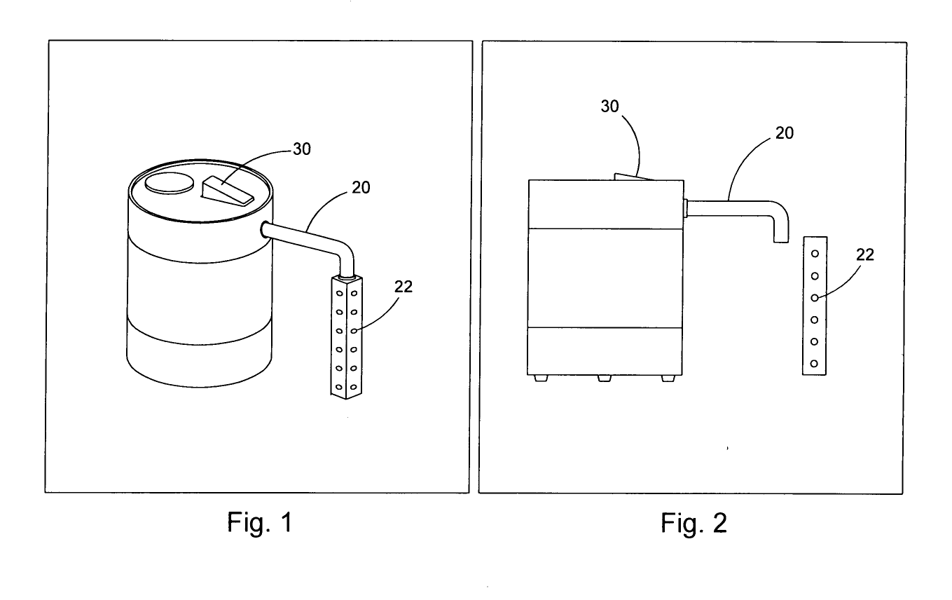

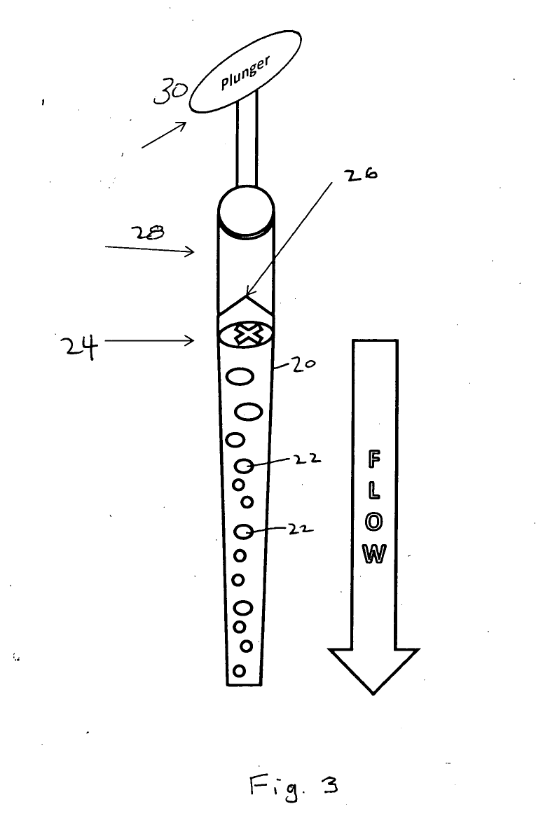

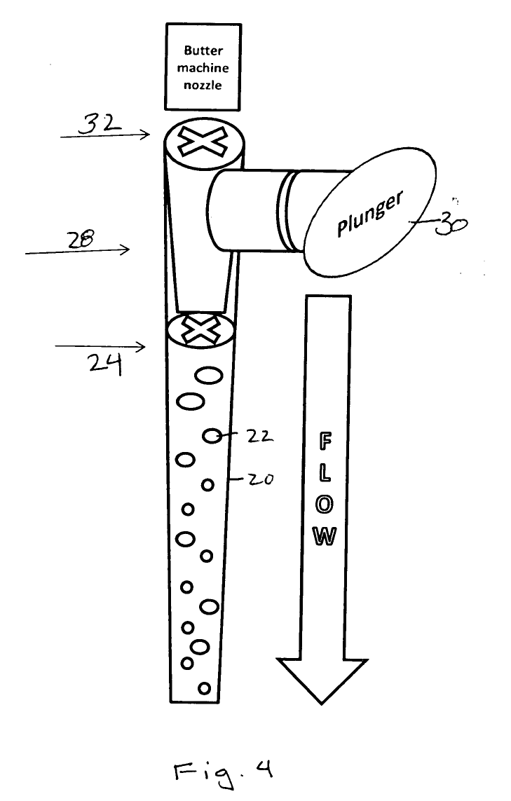

The present invention, hereinafter referred to as Popcorn Butter Dispenser, is a popcorn butter dispenser intended to enhance a wide array of commercial and residential butter dispensers to allow butter to be evenly distributed throughout an entire container of popcorn as opposed to coating only the kernels on top. This dispenser is able to function equally well with real melted butter as well as flavored oil based toppings. The popcorn butter dispenser is manufactured of suitable materials such as lightweight stainless steel, for example. The dispensing tube can have any suitable cross-section, such as circular, as seen in FIGS. 3 and 4, or four sided, as seen in FIGS. 1 and 2. The dispensing tube comprises hollow tubing measuring between approximately five and ten inches in length and one quarter inch in diameter. The length and circumference of this hollow tubing may vary with the type of butter dispenser, as they run the gamut of sizes from tabletop to stand alone industrial dispensers. Along the length of the dispenser tube is a series of perforations, with holes of varying size placed approximately one inch apart from one another and staggered on each face of the tubing, so no holes line up on any side. The purpose of this hole placement is to provide for even coating through an entire container of popcorn at each level from top to bottom and to optimize flow rate evenly through the container of popcorn.

In an embodiment the popcorn butter dispenser comprises a dispenser tube for attachment to the outlet port of a butter or flavor dispenser, wherein the dispenser comprises an elongate tube having perforations throughout its surface for the egress of butter or flavoring.

In an embodiment, it is contemplated that the butter or flavoring is contained in a cartridge having a membrane.

Please refer to FIG. 3. In an alternative embodiment, the popcorn butter dispenser for residential use comprises a dispensing tube 20 comprising an elongate tube having perforations 22 along its length. The upper portion of the elongate tube comprises a one-way diaphragm seal 24 through which butter or flavoring is dispensed by the perforation of a flavor or butter cartridge by conical nozzle 26. The butter or flavor cartridge is placed into the flavor chamber 28. When plunger 30 is depressed, the conical nozzle pierces the membrane covering of the flavor or butter cartridge allowing the butter or flavoring to pass from the flavor chamber 28 through the diaphragm seal 24 and into the dispensing tube 20. The butter or flavoring then passes through the holes 22 in the dispensing tube 20 and coats the popcorn kernels evenly.

FIG. 4 is designed for use with a conventional butter or flavor dispenser found in venues such as movie theaters. In this embodiment, the dispensing tube 20 attaches to the outlet port of a butter or flavoring machine and comprises a first one-way diaphragm 32 to prevent butter or flavoring from passing into the butter machine. The first one-way diaphragm 32 passes into the flavor chamber 28. Plunger 30 is perpendicular to the flow of the butter or flavoring in this embodiment. When plunger 30 is pushed in, the membrane of the flavoring or butter cartridge is pierced, thus allowing the butter or flavoring to pass into the flavor chamber 28 and through a second one-way valve 24, and into the dispensing tube 20, out through holes 22 and onto the pocorn.

The popcorn butter dispenser is simple to use. A user gently inserts one end of tubing into an existing spout of a selected topping dispenser. This tubing fits snugly enough to prevent any leakage where the tubing meets the machine. Once the popcorn butter dispenser is securely in place, the user takes a container of popcorn and holds it directly underneath the tubing. The user carefully moves a popcorn bag up over the tubing, keeping it centered so the tubing is as close to the container's center as possible. When the popcorn butter dispenser is in place, the user follows the manufacturers' directions and dispenses butter or flavored topping into the container. Dispensing butter usually is done with a built in pumping mechanism. The topping flows through the added tubing of the Popcorn Butter Dispenser and continues to flow neatly down a shaft to be expelled through the perforations. The butter reaches popcorn throughout the entire container and coats kernels evenly so the last popcorn bite is as flavorful as the first bite and no kernels are soggy. When finished using the added Popcorn Butter Dispenser, it is removed for easy cleaning with dish detergent and water.

While enhancing an individual's popcorn eating experience, the popcorn butter dispenser also provides a boost to businesses that generate income based on popcorn sales. Word of mouth advertising from impressed consumers adds to increased sales or even prompts a person with a hankering for tasty popcorn to go out of their way to fulfill that craving. If a bar serves the best popcorn in the area, as opposed to the bar down the street that serves a container of popcorn that is soggy on top and tastes like flavorless cardboard on the bottom, people will flock to the place that offers the more appealing popcorn. Vendor employees such as movie theater concession stand employees use their time more efficiently and serve more customers quickly by evenly dispersing popcorn butter with a single pump from the Popcorn Butter Dispenser. With adult supervision at home, children enjoy dispensing butter topping on their popcorn. The Popcorn Butter Dispenser is well received by businesses and domestic households.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A popcorn butter dispenser that coats kernels evenly throughout a container holding popcorn, comprising an elongate dispensing tube having perforations in the tube, wherein the elongate tube attaches to an outlet port of a butter or flavoring dispenser and the butter or flavoring passes through the perforations in the tube to coat the popcorn kernels.

2. The popcorn butter dispenser of claim 1 further comprising a one-way diaphragm seal, a flavor chamber, a butter or flavor cartridge having a membrane, a plunger, and a conical nozzle, wherein the butter or flavor cartridge is placed into the flavor chamber, the plunger is depressed causing the conical nozzle to pierce the membrane of the butter or flavor cartridge allowing the butter or flavoring to pass from the flavor cartridge into the flavor chamber and from the flavor chamber through the diaphragm seal and into the dispensing tube, and wherein the butter or flavoring then passes through the holes in the dispensing tube and coats the popcorn kernels evenly.

3. The popcorn butter dispenser of claim 1 wherein the dispensing tube is of circular cross-section.

4. The popcorn butter dispenser of claim 2 wherein the dispensing tube is of circular cross-section.

5. The popcorn butter dispenser of claim 1 wherein the dispensing tube is of essentially square cross-section.

6. The popcorn butter dispenser of claim 2 wherein the dispensing tube is of essentially square cross-section.

7. The popcorn butter dispenser of claim 1 wherein the dispensing tube is tapered, being narrower at the bottom than at the top.

8. The popcorn butter dispenser of claim 2 wherein the dispensing tube is tapered, being narrower at the bottom than at the top.

9. The popcorn butter dispenser of claim 1 wherein the dispensing tube comprises stainless steel.

10. The popcorn butter dispenser of claim 2 wherein the dispensing tube comprises stainless steel.

11. A popcorn butter dispenser designed for use with a conventional butter or flavoring dispensing machine found in venues such as movie theaters, comprising a first one-way diaphragm seal to prevent butter or flavoring from passing into the butter machine, a flavor chamber, a butter or flavoring cartridge having a membrane, a plunger, wherein the plunger is perpendicular to the flow of the butter or flavoring, a second one-way diaphragm seal, and a conical nozzle, wherein the butter or flavoring cartridge is placed into the flavor chamber, the plunger is pushed in causing the conical nozzle to pierce the membrane of the butter or flavoring cartridge allowing the butter or flavoring to pass from the butter or flavoring cartridge into the flavor chamber and from the flavor chamber through the second diaphragm seal and into the dispensing tube, and wherein the butter or flavoring then passes through the holes in the dispensing tube and coats the popcorn kernels evenly.
